(19) United States
(12) Patent Application Publication
(10) Pub. No.: US 2011/0296472 A1
(43) Pub. Date: Dec. 1, 2011

(54) CONTROLLABLE DEVICE COMPANION DATA

(75) Inventors: Eric R. Soldan, Saratoga, CA (US); Bradley R. Pettit, Los Gatos, CA (US); John Y. Affaki, San Jose, CA (US); Eduardo S.C. Takahashi, Cupertino, CA (US)

(73) Assignee: MICROSOFT CORPORATION, Redmond, WA (US)

(21) Appl. No.: 12/791,762

(22) Filed: Jun. 1, 2010

(51) Int. Cl. H04N 5/44; H04N 7/18

(52) U.S. Cl. 725/81; 348/734; 348/E05.096

(57) ABSTRACT

Controllable device companion data is described. In embodiments, a companion utility is executed by a portable device to interface the portable device with a controllable device via a wireless network. The portable device can communicate a request to the controllable device to initiate the controllable device sending a data source to the portable device, which receives the data source from the controllable device via the wireless network. The portable device then monitors the data source for a trigger event that initiates an action at the portable device.

### BACKGROUND

Current interaction with televisions, television set-top boxes, and/or other television devices generally involve a viewer controlling the devices with various remote controls. A typical home may include several televisions and/or television set-top boxes located throughout various rooms of the house. In addition, several different remote control devices are needed for all of the different brands and locations of the television devices. Typically, a user wanting to watch television enters a room of the house and needs to find the remote controls that correspond to the television and/or television set-top box that are located in the particular room of the house. Additionally, a conventional remote control device typically only allows a user to initiate various control operations of a television device, such as to change channels, adjust the volume, navigate a program guide, and select television programs and movies for viewing.

### SUMMARY

This summary is provided to introduce simplified concepts of controllable device companion data, and the concepts are further described below in the Detailed Description. This summary is not intended to identify essential features of the claimed subject matter, nor is it intended for use in determining the scope of the claimed subject matter.

Controllable device companion data is described. In embodiments, a companion utility is executed by a portable device to interface the portable device with a controllable device via a wireless network. The portable device can communicate a request to the controllable device to initiate the controllable device sending a data source to the portable device, which receives the data source from the controllable device via the wireless network. The portable device then monitors the data source for a trigger event that initiates an action at the portable device. In embodiments, a data source may be closed-caption data, metadata that is associated with media content, or any other type of content-associated data that can be monitored for a trigger event.

In other embodiments, the companion utility at a portable device can receive a user-generated trigger event that initiates an action at the portable device. The companion utility can detect a trigger event in the data source and initiate an action to execute a browser application, load media content related to the trigger event, and display the media content related to the trigger event. The portable device can then communicate a displayable portion of the media content to the controllable device for display, such as HTML data from a Web site that is displayed at the portable device. The companion utility can detect the trigger event in the data source and initiate an action to display an application at the portable device, where the application corresponds to media content that is displayed for viewing at the controllable device. The portable device can then communicate application data to the controllable device for display along with the media content that is displayed for viewing. The companion utility can also detect a trigger event in the data source and initiate an action to communicate a load command to the controllable device to initiate the controllable device requesting and loading content from a media content source.

In other embodiments, the data source corresponds to multiple television channels, and the companion utility can detect a trigger event associated with a television channel. The companion utility can then initiate an action to communicate a channel change command to the controllable device to switch to the television channel that is associated with the trigger event. The companion utility at the portable device may also detect, from the data source, a television channel that is tuned at the controllable device, and then initiate an action to display media content that is associated with a television program on the television channel at the portable device. The portable device can then communicate a displayable portion of the media content to the controllable device for approximate synchronous display with the television program that is displayed for viewing at the controllable device.

### BRIEF DESCRIPTION OF THE DRAWINGS

Embodiments of controllable device companion data are described with reference to the following drawings. The same numbers are used throughout the drawings to reference like features and components:

FIG. 1 illustrates an example environment in which embodiments of controllable device companion data can be implemented.

FIG. 2 illustrates an example system in which embodiments of controllable device companion data can be implemented.

FIG. 3 illustrates example method(s) of controllable device companion data in accordance with one or more embodiments.

FIG. 4 illustrates additional example method(s) of controllable device companion data in accordance with one or more embodiments.

FIG. 5 illustrates additional example method(s) of controllable device companion data in accordance with one or more embodiments.

FIG. 6 illustrates various components of an example device that can implement embodiments of controllable device companion data.

### DETAILED DESCRIPTION

Controllable device companion data is described. Embodiments provide that a controllable device, such as television set-top box in a home, can be paired with a portable device that is implemented as a controller of the controllable device. For example, a mobile phone may be implemented to function as a television remote control in a house that has multiple televisions and/or television set-top boxes, all within range of a wireless access point that provides wireless service throughout the rooms in the house. A companion utility can be implemented as software on a portable device to interface with various controllable devices.

In embodiments, a portable device can be paired to interface with a controllable device, such as a television set-top box, that receives media assets to display for viewing. For example, the television set-top box receives television programming and movies along with closed-caption data and metadata that corresponds to the media assets. The portable device can request that the controllable device communicate the closed-caption data, the metadata, or another data source to the portable device. In implementations, the closed-caption data may not be displayed at the controllable device or at the portable device. The portable device can receive and monitor the data source (e.g., the closed-caption data, metadata, or other data) for trigger events that initiate an action at the portable device. For example, a trigger event may be a television channel number and/or the name of a television program that then initiates the portable device to display information pertaining to the television program, such as a Web page that includes information about the television program. Additionally, the portable device can then communicate a displayable portion of the media content back to the controllable device for display along with the television program. Accordingly, the portable device can send non-control data, such as media content and information other than remote control inputs, to controllable devices.

While features and concepts of the described systems and methods for controllable device companion data can be implemented in any number of different environments, systems, and/or various configurations, embodiments of controllable device companion data are described in the context of the following example systems and environments.

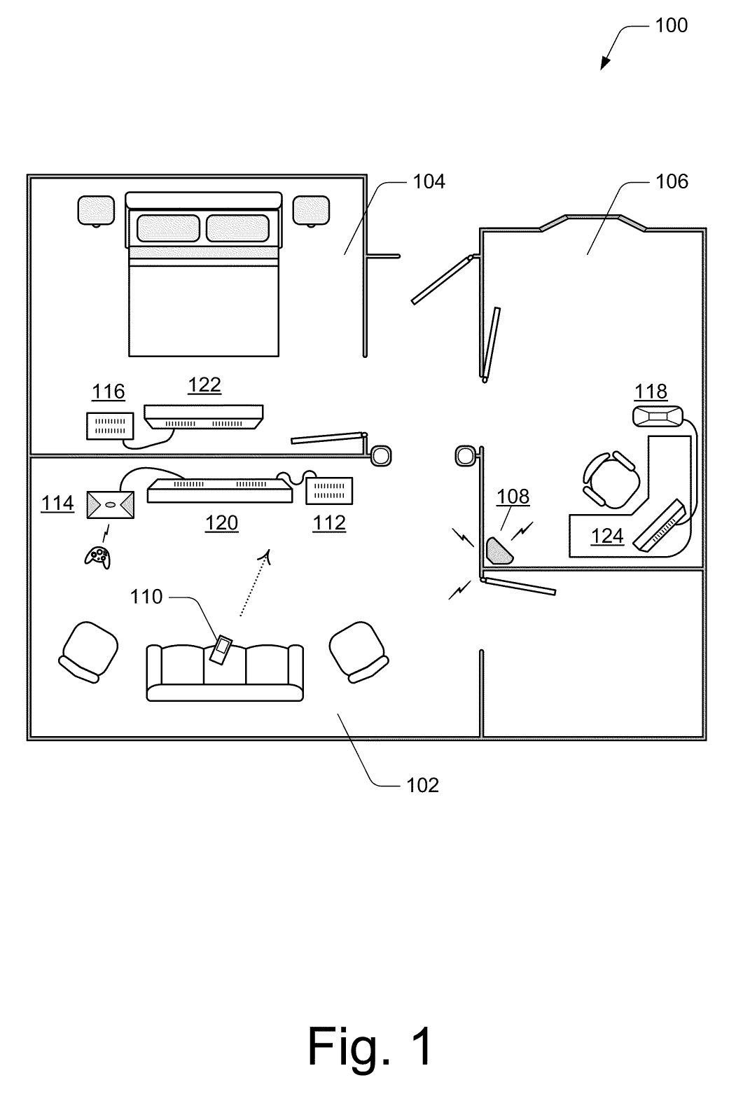

FIG. 1 illustrates an example environment 100 in which various embodiments of controllable device companion data can be implemented. The example environment 100 includes a representation of various rooms, such as in an apartment, house, or business. For purposes of this description, the various rooms are referred to as a living room 102, a bedroom 104, and an office 106. The office 106 includes a wireless access point 108 that implements a wireless network for wireless data communication throughout the various rooms of the building.

In embodiments, a portable device 110 can implement a companion utility that interfaces the portable device with a selected one of multiple controllable devices via the wireless network. A companion utility can be executed as a service on a device, or as a Web page in a browser application that supports wireless data communication. The portable device can then communicate input controls to a controllable device via the wireless network. In embodiments, the multiple controllable devices can each implement a companion application that interfaces with the companion utility of the portable device.

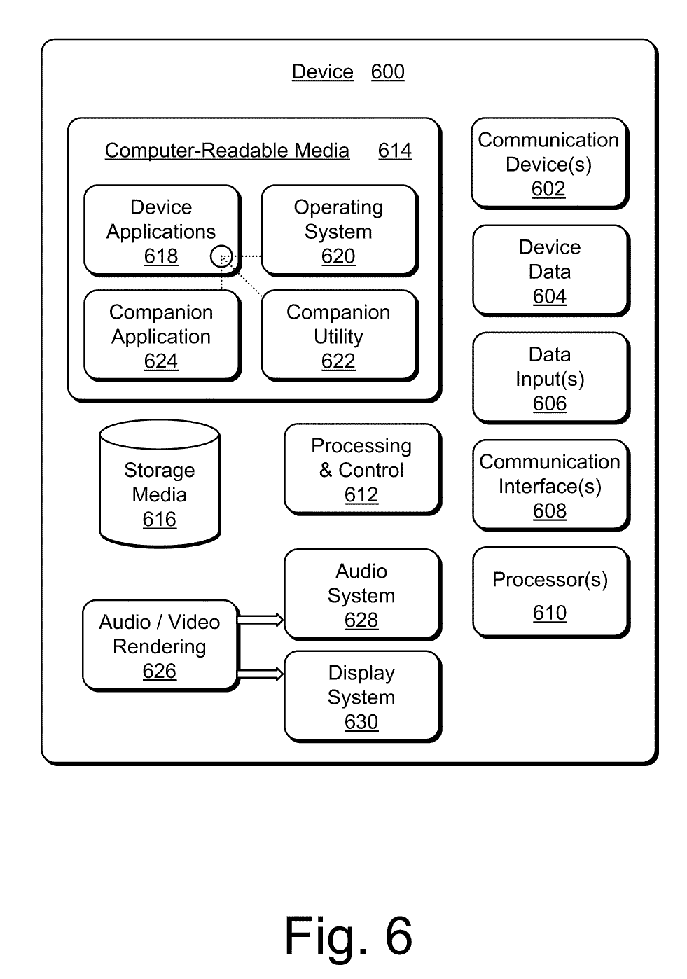

The portable device 110 may be any type of wireless device implemented to receive and/or communicate wireless data, such as any one or combination of a mobile phone (e.g., cellular, VoIP, WiFi, etc.), a portable computer device, a remote control device, a media device (e.g., a personal media player, portable media player, etc.), and/or any other type of portable device. The portable devices described herein are not limited to wireless devices, and may include a wired, yet portable device. Additionally, the portable device 110 can be implemented with any number and combination of differing components as further described with reference to the example device shown in FIG. 6.

The environment 100 also includes various examples of controllable devices, such as a television client device 112 (e.g., a television set-top box, a digital video recorder (DVR), etc.) and a gaming system 114 in the living room 102, an additional television client device 116 in the bedroom 104, and a computer device 118 in the office 106. Other controllable devices may include an appliance device, an electronic device, and/or any other type of client device or user device that may be implemented to receive control inputs from the portable device 110.

A client system can include a respective client device and display device that together render or playback any form of audio, video, and/or image media content, such as television programming For example, the television client device 112 and the gaming system 114 are connected to a display device 120 in the living room 102. Additionally, the television client device 116 is connected to a display device 122 in the bedroom 104, and the computer device 118 is connected to a display device 124 in the office 106. Any of the various display devices can be implemented as any type of a television, high definition television (HDTV), LCD, or similar display system.

Any of the various controllable devices can be configured and/or implemented with one or more processors, communication components, wired and/or wireless interfaces, memory components, signal processing and control circuits, and a media content rendering system. Further, any of the controllable devices can be implemented with any number and combination of differing components as further described with reference to the example device shown in FIG. 6.

The portable device 110 implements a companion utility that can be implemented as computer-executable instructions and executed by one or more processors to implement the various embodiments and/or features described herein. The companion utility can be paired with the various controllable devices to interface the devices for data communication via the wireless network. The portable device 110 can be paired with a controllable device utilizing unique identifiers and/or codes that are entered manually or communicated between the devices for auto-pairing. In this example environment 100, the portable device 110 is shown located in the living room 102. The companion utility implemented by the portable device can select the television client device 112 as the controllable device. When a controllable device is selected, the television client device 112 is configured for input control from the portable device.

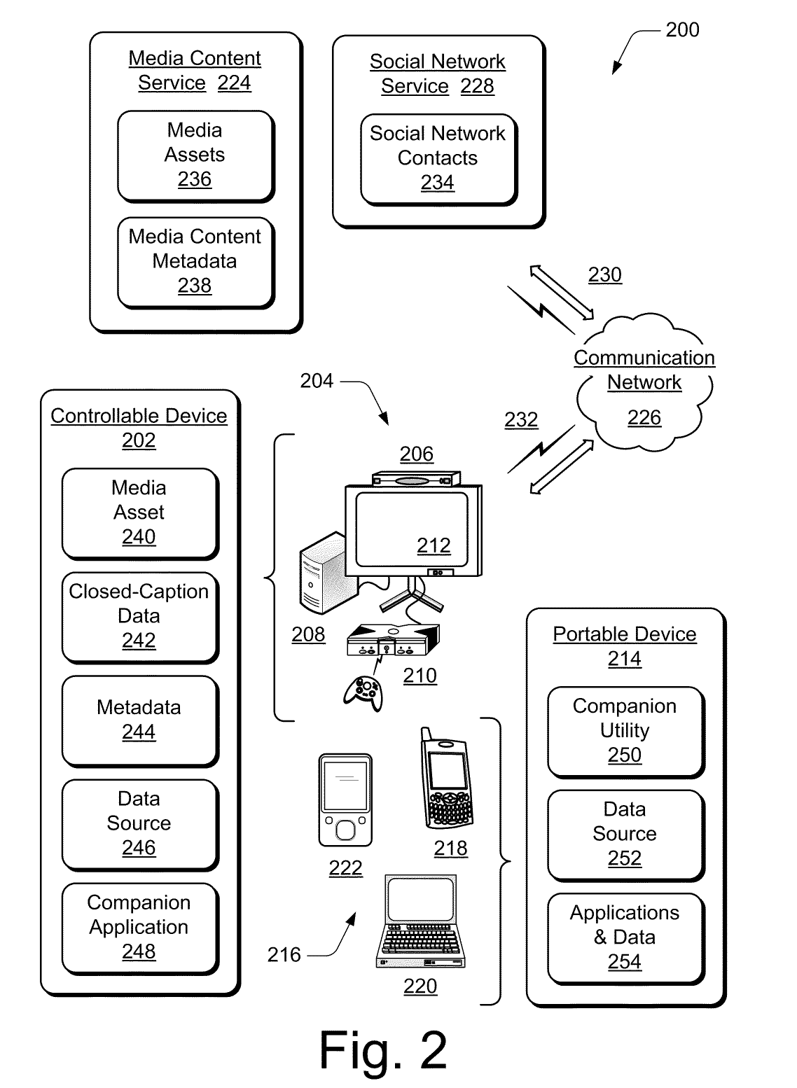

FIG. 2 illustrates an example system 200 in which various embodiments of controllable device companion data can be implemented. The example system 200 includes an example controllable device 202, which may be configured as any type of client device 204. Some of the various client devices 204 include wired and/or wireless devices, and may also be referred to as user devices and/or controllable devices. A client device 204 can be implemented as any one or combination of a television client device 206 (e.g., a television set-top box, a digital video recorder (DVR), etc.), a computer device 208, a gaming system 210, an appliance device, an electronic device, an advanced networked television device, and/or as any other type of controllable device that may be configured to be controlled by a portable device. A client system can include a respective controllable device and display device 212 that together render or playback any form of audio, video, and/or image media content and media assets. The display device 212 can be implemented as any type of a television, high definition television (HDTV), LCD, or similar display system.

The example system 200 also includes an example portable device 214, which may be configured as any type of portable device 216 that may be implemented to receive, display, and/or communicate data for input control of one or more controllable devices. The various portable devices 216 can include wireless devices implemented to receive and/or communicate wireless data, such as any one or combination of a mobile phone 218 (e.g., cellular, VoIP, WiFi, etc.), a portable computer device 220, a media device 222 (e.g., a personal media player, portable media player, etc.), and/or any other wireless device that can receive media content in any form of audio, video, and/or image data. Each of the various portable devices can include an integrated display and/or an integrated touch-screen, as well as selectable input controls via which a user can input data and/or selections.

Any of the various client devices 204 and/or portable devices 216 can be implemented with one or more processors, communication components, wired and/or wireless interfaces, data inputs, memory components, signal processing and control circuits, and a media content rendering system. Additionally, any of the various client devices 204 and/or portable devices 216 can be implemented with any number and combination of differing components as further described with reference to the example device shown in FIG. 6. A client device or portable device may also be associated with a user (i.e., a person) and/or an entity that operates the device such that a device describes logical devices that include users, software, and/or a combination of devices.

The example system 200 includes a media content service 224 that communicates or otherwise provides media content and data to any number of the various client devices 204 and portable devices 216 via a communication network 226. The example system 200 may also include a social network service 228 that supports social networking by users of the various client devices and portable devices.

The communication network 226 can be implemented to include a broadcast network, an IP-based network 230, and/or a wireless network 232 that facilitates media asset distribution and data communication between the media content service 224, the social network service 228, and any number of the various client devices 204 and portable devices 216. The communication network 226 can also be implemented using any type of network topology and/or communication protocol, and can be represented or otherwise implemented as a combination of two or more networks. The communication network 226 may also include a mobile operator network that is managed by a communication service provider, such as a cell-phone provider and/or Internet service provider, to facilitate mobile data and/or voice communications for any type of a wireless device or mobile phone (e.g., cellular, VoIP, Wi-Fi, etc.).

The social network service 228 may be implemented as any type of social network site that provides for social network contacts 234 based on any one or combination of social groups, such as co-workers, friends, family, a group based on common interests, a group of unknown contacts that are linked based on some commonality, and so on. The social network contacts 234 can utilize the social network service 228 as a basis to permit sharing of media content, photos, blogs, updates, and the like. The social network service 228 may use a permissioning technique, such as a selected or allowed relationship, to permit or restrict access to content associated with a user account of the social network service. For example, a user of the portable device 214 may have an associated user account with the social network service 228, and via the portable device 214, the user can select and allow social network contacts of the user.

The media content service 224 can include media content servers to communicate, or otherwise distribute, media content and/or other data to any number of the various client and/or portable devices. In this example system 200, the media content service 224 includes media assets 236 and media content metadata 238. Additionally, the media content service 224 may be implemented as a subscription-based service from which any of the various devices can request media assets 236 to download and display for viewing, or otherwise render for playback. The media content service 224 manages the media asset distribution to the various devices, such as when a request for a media asset 236 is received from a client device 204, and the media content service 224 communicates or provides data segments of the media asset to the client device.

The media assets 236 can include any type of audio, video, and/or image data received from any type of media content source or data source. As described throughout, media assets are media content, and media assets can include music (e.g., digital music files of songs), television programming, movies, on-demand media assets, interactive games, network-based applications, and any other audio, video, and/or image data (e.g., to include program guide data, user interface data, advertising content, closed-caption data, content metadata, search results and/or recommendations, etc.). A media asset 236 may also include various display formats of the media asset, such as a highest quality display format (e.g., a highest quality, high-definition display format) to a lower quality display format (e.g., a lower quality, standard-definition display format), and any other quality of display format along a continuum between the two.

The media content metadata 238 can include any type of identifying criteria, descriptive information, and/or attributes associated with the media assets 236 that describes and/or categorizes the media assets. For example, metadata can include a media asset identifier, title, subject description, a date of production, artistic information, music compilations, teletext, subtitles, call-letters, cast and/or crew information, and any other types of descriptive information about a particular media asset. Further, metadata can characterize a genre that describes a media asset, such as video content, as being an advertisement, a movie, a comedy show, a sporting event, a news program, a sitcom, a talk show, an action/adventure program, or as any number of other category descriptions. Additionally, the media content metadata 238 can include closed-caption data that is associated with a media asset 236, as well as a television channel number or numbers associated with the media asset.

The example controllable device 202 can receive and playback a media asset 240 from the media content service 224 or from any other media content source. The controllable device 202 also receives closed-caption data 242, metadata 244, and/or any other type of data source 246 that corresponds to the media asset 240. For example, the television client device 206 can receive a television program or movie for display on the display device 212. The television client device 206 can also receive the closed-caption data 242 that corresponds to the television program or movie. Optionally, the closed-caption data 242 can also be displayed over the television program or movie on the display device. The example controllable device 202 also includes a companion application 248 that can be implemented as computer-executable instructions and executed by one or more processors to implement the various embodiments described herein. For example, the companion application 248 configures the controllable device 202 to interface with a portable device that is implemented as a controller of the controllable device.

The portable device 214 includes a companion utility 250 that can be implemented as computer-executable instructions and executed by one or more processors to implement the various embodiments described herein. For example, the companion utility 250 configures the portable device 214 to interface with a controllable device via a wireless network (e.g., via the wireless access point 108 as described with reference to FIG. 1). The companion utility 250 can generate a request that is communicated to the controllable device 202 to initiate the controllable device sending the data source 246, which is received as the data source 252 at the portable device. The data source 252 may be received at the portable device 214 as closed-caption data, metadata, or as any other media asset or media content related data. It should be noted that when closed-caption data is received, it may not necessarily be rendered for display at either the controllable device or at the portable device. The closed-caption data can be received at the controllable device 202, along with the associated media asset 240, and then communicated to the portable device 214 without being displayed. Optionally, closed-caption data may be requested that does not correlate to a particular media asset being displayed for viewing at the controllable device 202.

The companion utility 250 at the portable device 214 can monitor the data source 252 for a trigger event that initiates an action at the portable device. A trigger event may be determined or recognized as any of the metadata criteria, information, or attributes as described above, as well as any text or information in closed-caption data, or a television channel number. In this instance, the companion utility 250 may monitor the closed-caption data 252 for a trigger event that initiates an action, such as to communicate a channel change command back to the controllable device 202 when a trigger event is detected.

The companion utility 250 can monitor for a trigger event, such as a word, text string, television channel number, an embedded trigger that initiates an action at the portable device, and/or any other type of trigger event that may be monitored for and detected. Optionally, a trigger event may be user-definable, such as a user-defined particular term or television channel number that the companion utility monitors for and detects. The companion utility 250 can receive a user-generated trigger event that initiates an action at the portable device. For example, a user of the portable device 214 can interact with a on-screen presentation at the controllable device 202 (e.g., media asset 240 displayed on display device 212) by requesting any kind of data from various media content data sources and sending that data to the controllable device 202 for presentation on the display device.

When the companion utility 250 detects a trigger event in the data source 252, the companion utility can then initiate an action at the portable device. In an embodiment, the companion utility can initiate the action to execute a browser application, load media content related to the trigger event, and display the media content related to the trigger event. The portable device 214 includes various applications and data 254, such as a browser application that can be executed to display a Web page (e.g., media content) received from the media content service 224.

In an example, the media asset 240 that is displayed for viewing at the controllable device 202 (e.g., on display device 212) may be a television program, such as a cooking show where the host is filmed creating a food dish. The closed-caption data that is associated with the television program can include trigger events, such as the television channel number that the television program is broadcast over, an identifier of the particular cooking show, and/or the name of the host of the show. Any number of other various trigger events that correspond to the television program can be included in the data source and detected by the companion utility 250 at the portable device. When any of the various trigger events that correspond to the television program are detected and resolved, the companion utility 250 can initiate a browser application 254 at the portable device to display a Web page that correlates to the cooking show. The Web page may include additional information about the particular episode of the cooking show, a bio of the host, recipes of food dishes that have been featured on the program, and the like.

In another example, the media asset 240 that is displayed for viewing at the controllable device 202 (e.g., on display device 212) may be a sporting event, such as a football game. The data source (e.g., closed-caption data or metadata) that is associated with the sporting event can include trigger events, such as the television channel number that the sporting event is broadcast over, an identifier of the particular football game, and/or the names of participants. Any number of other various trigger events that correspond to the sporting event can be included in the data source and detected by the companion utility 250 at the portable device. When any of the various trigger events that correspond to the television program are detected and resolved, such as the name of a player that has been injured, or a player that has just scored points, the companion utility 250 can initiate a browser application at the portable device and display a Web page that correlates to the player. The Web page may include information about the player, his career, and the current team that he plays for, as well as other similar information.

In another example, the data source 252 at the portable device 214 may correspond to multiple television channels that are received at the controllable device 202 (e.g., at the television client device 206). The companion utility 250 can detect a trigger event in the data source 252 that is associated with a television channel and initiate an action at the portable device 214 to communicate a channel change command to the controllable device 202 to switch to the television channel that is associated with the trigger event. Any of the multiple television channels or streams that are received at the controllable device 202 may not be currently displayed as the media asset 240. The companion utility can monitor for a trigger event in one or more of the television channel streams, while only one (or none) of the television channels are displayed for viewing at the controllable device 202. For example, an user of the portable device 214 may want to be notified when a particular television program starts on a television channel, while watching a different television program on a different channel. In another example, the user may want to be notified when a player scores in a sporting event, and the companion utility 250 can monitor the multiple television channels (e.g., data source 252) for any such triggering events. The companion utility 250 can then initiate the action at the portable device 214 to communicate a channel change command to the controllable device 202 to switch to the television channel that is associated with the trigger event.

In other examples, the companion utility 250 may detect the name of a particular music artist in the data source 252, and initiate an action to display song selections from that music artist at the portable device 214. The companion utility 250 may detect from the data source that the controllable device 202 is tuned to a particular television channel on which an auto auction is displayed for viewing (e.g., on display device 212 when the television client device 206 is tuned to the particular television channel). The companion utility 250 can then initiate a browser application at the portable device 214 and display a Web page that correlates to the current car that is being auctioned, and information about the car may include more pictures from various perspectives as well as detailed specifications about the car.

In an embodiment of controllable device companion data, the companion utility 250 at the portable device 214 can initiate communication of a displayable portion of the media content to the controllable device 202 for display. Alternatively or in addition, a user of the portable device 214 may initiate sending the displayable portion of the media content to the controllable device 202 for display. For example, the absence of a data source or closed-caption data does not preclude a user from sending displayable data from the portable device 214 into the controllable device 202. A user may also author data at the portable device 214 by means of an application 254 and send the authored data to the controllable device 202.

The displayable portion of the media content can be HTML data from a Web site that is displayed at the portable device. For example, a recipe that is included on the Web page displayed at the portable device 214 can be communicated from the portable device to the controllable device 202 that displays the recipe over the cooking television program on which the host is creating the particular food dish of the recipe. In this instance, the recipe can be displayed to more than one viewer, such as when a group of people are watching the cooking show together and, rather than pass the portable device around for each person to individually view the recipe, the recipe is displayed to the whole group. The controllable device 202 can be implemented to receive displayable media content from the portable device 214 and, depending on a format of the media content and the display capabilities of the controllable device, display the media content as HTML data, a bitmap image, a picture-in-picture window, and/or by any other display technique.

In another embodiment, the companion utility 250 at the portable device 214 can initiate an action to display an application (e.g., applications and data 254) at the portable device when a trigger event is detected. The application may correspond to the media content that is displayed for viewing at the controllable device 202. For example, a recipe creation application may be initiated for display at the portable device when the companion utility 250 detects a trigger event in the closed-caption data that corresponds to the television cooking show which is displayed for viewing at the controllable device 202. A user of the portable device may then author a recipe while following along when viewing the cooking show. In an embodiment, the companion utility 250 can then initiate communication of application data to the controllable device 202 for display. For example, the authored recipe may be displayable media content that is displayed for viewing over the cooking television program at the controllable device 202 (e.g., displayed on the display device 212 when received by the television client device 206).

In another embodiment, the companion utility 250 at the portable device 214 can detect a trigger event in the data source 252 and initiate an action at the portable device 214 to communicate a load command to the controllable device 202 to initiate the controllable device requesting and loading content from a media content source or other third-party. In addition to the portable device 214 receiving a trigger event (e.g., in the data source 252) and loading media content at the portable device, and/or the portable device 214 communicating a load command to the controllable device 202 to initiate the controllable device loading media content, the companion utility 250 can fetch or request trigger definitions, such as from the media content service or from any Web-based source, and register the definitions with the controllable device 202.

In another embodiment, the companion utility 250 at the portable device 214 can detect, from the data source, a television channel that is tuned at the controllable device 202 and initiate an action to display media content that is associated with the television channel at the portable device. The companion utility 250 can then initiate communication of a displayable portion of the media content to the controllable device 202 for approximate synchronous display with a television program that is displayed for viewing at the controllable device.

For example, the controllable device 202 may be tuned to a particular television sports channel, which is detected as a trigger event from the data source by the companion utility 250 at the portable device 214. The companion utility can then initiate execution of a browser application at the portable device to receive media content about a player that has just scored points in a sporting event. The media content about the player that corresponds to the scoring play shown on the television sports channel can be received from the media content service 224 and/or from any number of other media content sources. The media content about the player that corresponds to the television sports channel can then be communicated from the portable device 214 to the controllable device 202 for approximate synchronous display with the televised sporting event that is displayed for viewing at the controllable device.

Additionally, the companion utility 250 at the portable device 214 and/or the media content service 224 can communicate the displayable media content to one or more of the social network contacts 234 at the social network service 228 for a shared viewing experience. For example, a user at the portable device 214 may invite a friend, or friends (e.g., the social network contacts 234), to watch the televised sporting event while the user also watches the television program, and the respective client devices of the social network contacts 234 receive the displayable media content, or authored media content, from the user at the portable device 214. The friends can then watch the television program together at the same time, as well as chat and comment about the television program.

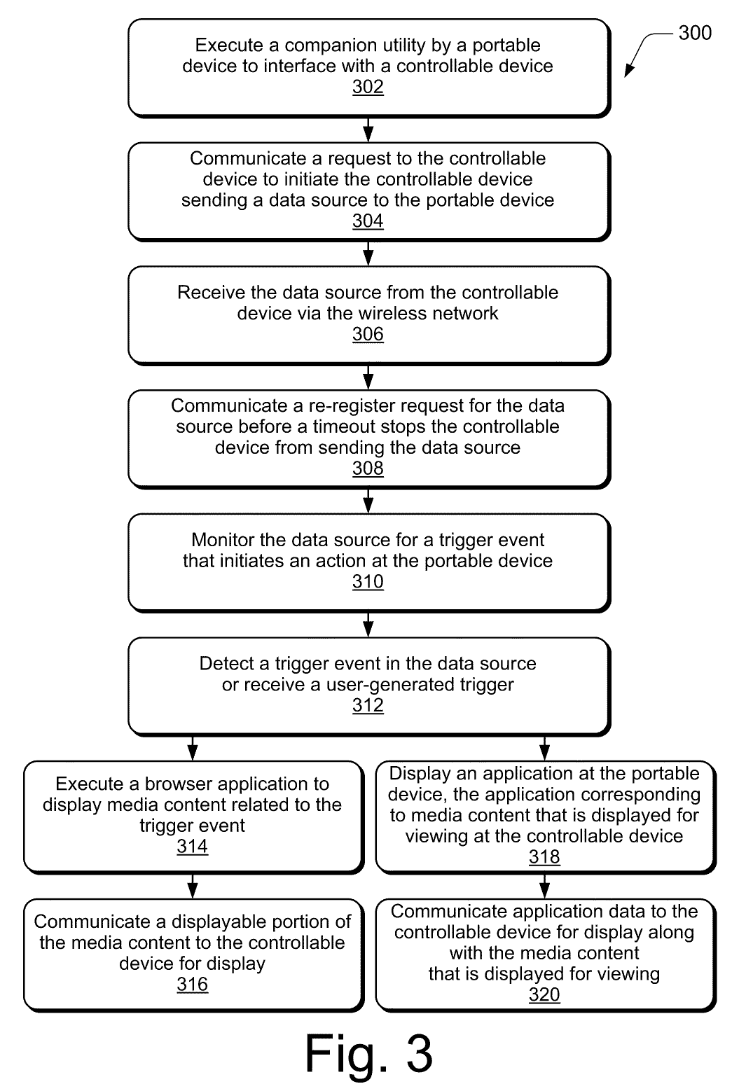

Example methods 300, 400, and 500 are described with reference to respective FIGS. 3, 4, and 5 in accordance with one or more embodiments of controllable device companion data. Generally, any of the functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable memory devices, both local and/or remote to a computer processor. The methods may also be practiced in a distributed computing environment by multiple computer devices. Further, the features described herein are platform-independent and can be implemented on a variety of computing platforms having a variety of processors.

FIG. 3 illustrates example method(s) 300 of controllable device companion data, and is described with reference to a portable device that interfaces with a controllable device. The order in which the method blocks are described are not intended to be construed as a limitation, and any number of the described method blocks can be combined in any order to implement a method, or an alternate method.

At block 302, a companion utility is executed by a portable device to interface with a controllable device via a wireless network. For example, the portable device 214 (FIG. 2) executes the companion utility 250 to interface the portable device with a selected one of various client devices 204 (e.g., controllable devices) via a wireless network. The companion utility 250 can be executed as a service on the portable device 214, and the companion utility interfaces the portable device with a companion application 248 that is executed on a controllable device 202.

At block 304, a request is communicated to the controllable device to initiate the controllable device sending a data source to the portable device and, at block 306, the data source is received from the controllable device via the wireless network. For example, the companion utility 250 at the portable device 214 generates a request that is communicated to the controllable device 202 to initiate the controllable device sending the data source 246, which is received as the data source 252 at the portable device. The data source 252 may be received at the portable device 214 as closed-caption data, metadata, or as any other media asset or media content related data. Optionally, the data source may be requested that does not correlate to a particular media asset being displayed for viewing at the controllable device 202.

At block 308, a re-register request for the closed-caption data is communicated before a timeout stops the controllable device from sending the closed-caption data to the portable device. For example, the companion utility 250 generates a re-register request for the data source 242 from the controllable device 202 before a timeout stops the controllable device from sending out the data source. In an implementation, the delivery of the data source to the portable device is not over a persistent connection and is periodically refreshed. Otherwise, the controllable device can stop using its resources to communicate the data source if the portable device is no longer receiving the data source.

At block 310, the data source is monitored for a trigger event that initiates an action at the portable device and, at block 312, a trigger event is detected in the data source or received as a user-generated trigger. For example, the companion utility 250 at the portable device 214 monitors the data source 252 for a trigger event that initiates an action at the portable device, and detects a trigger event, such as a word, text string, television channel number, an embedded trigger that initiates an action at the portable device, and/or any other type of trigger event that may be monitored for and detected. Alternatively or in addition, the companion utility 250 receives a user-generated trigger event that initiates an action at the portable device.

Optionally, at block 314, a browser application is executed to display media content related to the trigger event. For example, when the trigger event is detected, the companion utility 250 initiates the action to execute a browser application at the portable device to display media content related to the trigger event. Additionally, at block 316, a displayable portion of the media content is communicated to the controllable device for display. For example, the portable device 214 communicates a displayable portion of the media content to the controllable device 202 for display, such as HTML data from a Web site that is displayed at the portable device.

Optionally, at block 318, an application is displayed at the portable device, where the application corresponds to media content that is displayed for viewing at the controllable device. For example, when the trigger event is detected, the companion utility 250 initiates the action to display an application at the portable device 214. Additionally, at block 320, application data is communicated to the controllable device for display along with the media content that is displayed for viewing. For example, the portable device 214 communicates the application data to the controllable device 202 for display along with the media content that is displayed for viewing at the controllable device (e.g., such as a television program received by television client device 206 and displayed for viewing on display device 212).

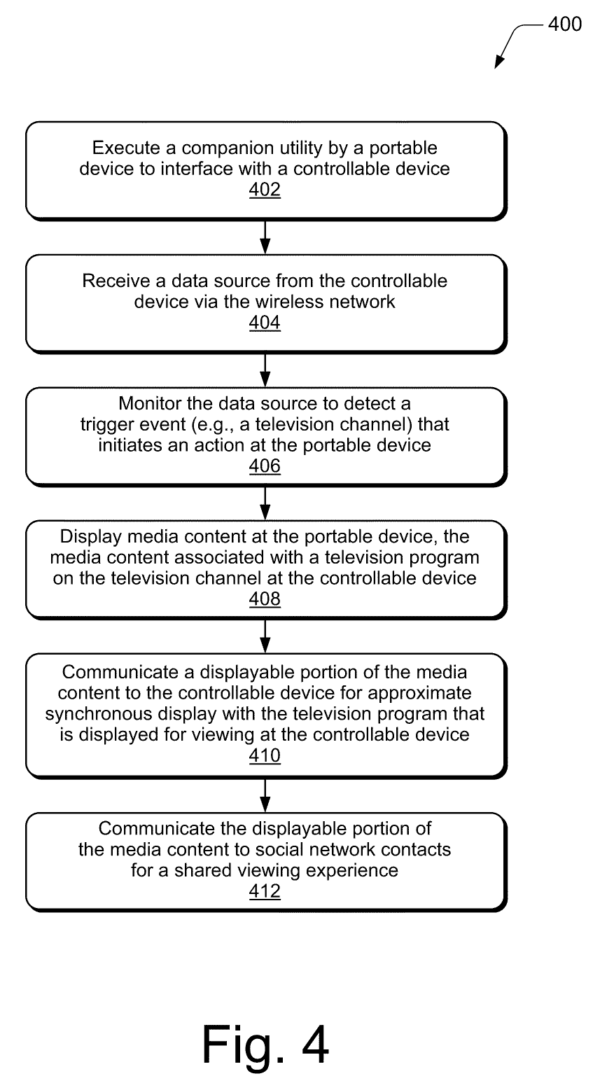

FIG. 4 illustrates example method(s) 400 of controllable device companion data. The order in which the method blocks are described are not intended to be construed as a limitation, and any number of the described method blocks can be combined in any order to implement a method, or an alternate method.

At block 402, a companion utility is executed by a portable device to interface with a controllable device via a wireless network. For example, the portable device 214 (FIG. 2) executes the companion utility 250 to interface the portable device with a selected one of various client devices 204 (e.g., controllable devices) via a wireless network. The companion utility 250 can be executed as a service on the portable device 214, and the companion utility interfaces the portable device with a companion application 248 that is executed on a controllable device 202.

At block 404, a data source is received from the controllable device via the wireless network. For example, the portable device 214 receives the data source 242 from the controllable device 202. At block 406, the data source is monitored to detect a trigger event that initiates an action at the portable device. For example, the companion utility 250 at the portable device 214 monitors the data source 252 to detect a trigger event that initiates an action at the portable device. For instance, the companion utility 250 detects, from the data source, a television channel that is tuned at the controllable device 202.

At block 408, media content is displayed at the portable device, the media content being associated with a television program on the television channel at the controllable device. For example, the companion utility 250 initiates a display of media content at the portable device 214 when the television channel (e.g., trigger event) is detected in the data source.

At block 410, a displayable portion of the media content is communicated to the controllable device for approximate synchronous display with the television program that is displayed for viewing at the controllable device. For example, the portable device 214 communicates a displayable portion of the media content to the controllable device 202 for approximate synchronous display with the television program (e.g., media asset 240) that is displayed for viewing at the controllable device (e.g., on display device 212).

At block 412, the displayable portion of the media content is communicated to social network contacts for a shared viewing experience. For example, the companion utility 250 at the portable device 214 communicates the displayable media content to one or more of the social network contacts 234 at the social network service 228 for a shared viewing experience. In an implementation, the social network contacts may be invited to share the viewing experience with communication direct from the portable device 214 and/or via the media content service 224. For example, a user at the portable device 214 may invite a friend, or friends (e.g., the social network contacts 234), to watch a television program while the user also watches the television program, and the respective client devices of the social network contacts 234 receive the displayable media content from the user at the portable device 214.

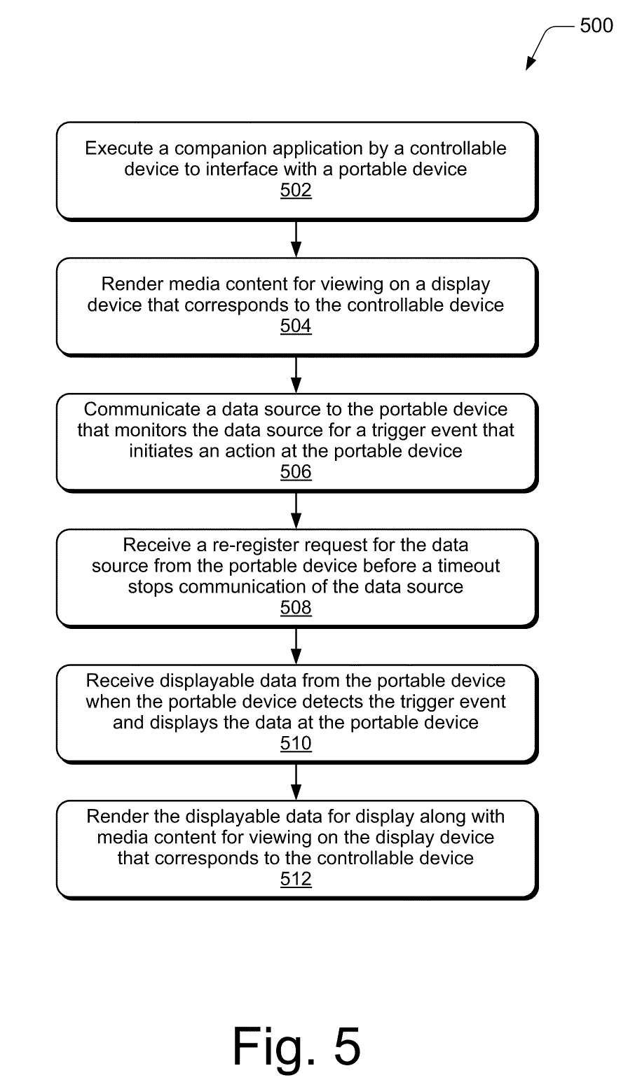

FIG. 5 illustrates example method(s) 500 of controllable device companion data, and is described with reference to a controllable device that interfaces with a portable device implemented as a controller. The order in which the method blocks are described are not intended to be construed as a limitation, and any number of the described method blocks can be combined in any order to implement a method, or an alternate method.

At block 502, a companion application is executed by a controllable device to interface with a portable device via a wireless network. For example, the controllable device 202 (FIG. 2) executes the companion application 248 to interface the controllable device with the portable device 214 via a wireless network. The companion application 248 can be executed as a service on the controllable device 202, and the companion application interfaces the controllable device with a companion utility 250 that is executed on the portable device 214.

At block 504, media content is rendered for viewing on a display device that corresponds to the controllable device. For example, the controllable device 202 receives a media asset 240, such as a television program or movie, from the media content service 224, and renders the media asset for viewing on the display device 212 (e.g., when rendered by the television client device 206).

At block 506, a data source is communicated to the portable device that monitors the closed-caption data for a trigger event, which initiates an action at the portable device. For example, the controllable device 202 receives the data source 242 that corresponds to the media asset 240, and communicates the data source to the portable device 214, which monitors the data source for a trigger event that initiates an action at the portable device.

At block 508, a re-register request for the data source is received from the portable device before a timeout stops communication of the data source to the portable device. For example, the controllable device 202 receives a re-register request for the data source 242 from the portable device 214 before a timeout stops the controllable device from sending out the data source. In an implementation, the delivery of the data source to the portable device is not over a persistent connection and is periodically refreshed. Otherwise, the controllable device can stop using its resources to communicate the data source if the portable device is no longer receiving the data source.

At block 510, displayable data is received from the portable device when the portable device detects the trigger event and displays the data at the portable device. For example, the controllable device 202 receives displayable data from the portable device 214 when the portable device detects, from the data source, a television channel that is tuned at the controllable device.

At block 512, the displayable data is rendered for display along with media content for viewing on the display device that corresponds to the controllable device. For example, the controllable device 202 renders the displayable data for display along with media content that is displayed for viewing on the display device 212. The displayable data may include HTML data from a Web site that is displayed at the portable device 214, or application data that is authored at the portable device. Optionally, the displayable data is rendered for approximate synchronous display along with the television program on the display device that corresponds to the controllable device.

FIG. 6 illustrates various components of an example device 600 that can be implemented as any type of portable, controllable, and/or computing device as described with reference to the previous FIGS. 1-5 to implement embodiments of controllable device companion data. In embodiments, device 600 can be implemented as any one or combination of a wired and/or wireless device, as any form of television client device (e.g., television set-top box, digital video recorder (DVR), etc.), consumer device, computer device, server device, portable computer device, user device, communication device, video processing and/or rendering device, appliance device, gaming device, electronic device, and/or as any other type of device. Device 600 may also be associated with a user (i.e., a person) and/or an entity that operates the device such that a device describes logical devices that include users, software, firmware, and/or a combination of devices.

Device 600 includes communication devices 602 that enable wired and/or wireless communication of device data 604 (e.g., received data, data that is being received, data scheduled for broadcast, data packets of the data, etc.). The device data 604 or other device content can include configuration settings of the device, media content stored on the device, and/or information associated with a user of the device. Media content stored on device 600 can include any type of audio, video, and/or image data. Device 600 includes one or more data inputs 606 via which any type of data, media content, and/or inputs can be received, such as user-selectable inputs, messages, music, television media content, recorded video content, and any other type of audio, video, and/or image data received from any content and/or data source.

Device 600 also includes communication interfaces 608 that can be implemented as any one or more of a serial and/or parallel interface, a wireless interface, any type of network interface, a modem, and as any other type of communication interface. The communication interfaces 608 provide a connection and/or communication links between device 600 and a communication network by which other electronic, computing, and communication devices communicate data with device 600.

Device 600 includes one or more processors 610 (e.g., any of microprocessors, controllers, and the like) which process various computer-executable instructions to control the operation of device 600 and to implement embodiments of controllable device companion data. Alternatively or in addition, device 600 can be implemented with any one or combination of hardware, firmware, or fixed logic circuitry that is implemented in connection with processing and control circuits which are generally identified at 612. Although not shown, device 600 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 600 also includes computer-readable storage media 614, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 600 can also include a mass storage media device 616.

Computer-readable storage media 614 provides data storage mechanisms to store the device data 604, as well as various device applications 618 and any other types of information and/or data related to operational aspects of device 600. For example, an operating system 620 can be maintained as a computer application with the computer-readable storage media 614 and executed on processors 610. The device applications 618 can include a device manager implemented as any one or combination of a control application, software application, signal processing and control module, code that is native to a particular device, a hardware abstraction layer for a particular device, etc.

The device applications 618 also include any system components or modules to implement embodiments of controllable device companion data. In this example, the device applications 618 can include a companion utility 622, such as when the device 600 is implemented as a portable device. Alternatively or in addition, the device applications 618 can include a companion application 624, such as when the device 600 is implemented as a controllable device. The companion utility 622 and the companion application 624 are each shown as software modules and/or computer applications. Alternatively or in addition, the companion utility 622 and/or the companion application 624 can be implemented as hardware, software, firmware, or any combination thereof

Device 600 also includes an audio and/or video rendering system 626 that generates and provides audio data to an audio system 628 and/or generates and provides display data to a display system 630. The audio system 628 and/or the display system 630 can include any devices that process, display, and/or otherwise render audio, display, and image data. Display data and audio signals can be communicated from device 600 to an audio device and/or to a display device via an RF (radio frequency) link, S-video link, composite video link, component video link, DVI (digital video interface), analog audio connection, or other similar communication link. In an embodiment, the audio system 628 and/or the display system 630 are implemented as external components to device 600. Alternatively, the audio system 628 and/or the display system 630 are implemented as integrated components of example device 600.

Although embodiments of controllable device companion data have been described in language specific to features and/or methods, it is to be understood that the subject of the appended claims is not necessarily limited to the specific features or methods described. Rather, the specific features and methods are disclosed as example implementations of controllable device companion data.

1. A portable device, comprising:
at least a memory and a processor that implement a companion utility configured to interface the portable device with a controllable device via a wireless network, the companion utility further configured to:
generate a request for communication to the controllable device to initiate the controllable device sending a data source to the portable device;
receive the data source from the controllable device via the wireless network; and
monitor the data source for a trigger event that initiates an action at the portable device.

2. A portable device as recited in claim 1, wherein the companion utility is further configured to detect the trigger event in the data source and initiate the action to execute a browser application, load media content related to the trigger event, and display the media content related to the trigger event.

3. A portable device as recited in claim 2, wherein the companion utility is further configured to initiate communication of at least a displayable portion of the media content to the controllable device for display.

4. A portable device as recited in claim 1, wherein the companion utility is further configured to receive a user-generated trigger event that initiates the action at the portable device.

5. A portable device as recited in claim 1, wherein the companion utility is further configured to detect the trigger event in the data source and initiate the action to display an application at the portable device, the application corresponding to media content that is displayed for viewing at the controllable device.

6. A portable device as recited in claim 1, wherein the companion utility is further configured to detect the trigger event in the data source and initiate the action to communicate a load command to the controllable device to initiate the controllable device requesting and loading content from a media content source.

7. A portable device as recited in claim 1, wherein the data source corresponds to multiple television channels, and wherein the companion utility is further configured to detect the trigger event associated with a television channel and initiate the action to communicate a channel change command to the controllable device to switch to the television channel that is associated with the trigger event.

8. A portable device as recited in claim 1, wherein the companion utility is further configured to detect, from the data source, a television channel that is tuned at the controllable device and initiate the action to display media content that is associated with the television channel at the portable device.

9. A portable device as recited in claim 8, wherein the companion utility is further configured to initiate communication of at least a displayable portion of the media content to the controllable device for approximate synchronous display with a television program that is displayed for viewing at the controllable device.

10. A portable device as recited in claim 1, wherein the data source is closed-caption data that is not rendered for display at the controllable device or at the portable device.

11. A method implemented by a portable device, the method comprising:
executing a companion utility with a processor of the portable device, the companion utility configured to interface the portable device with a controllable device via a wireless network;
communicating a request to the controllable device to initiate the controllable device sending a data source to the portable device;
receiving the data source from the controllable device via the wireless network; and
monitoring the data source for a trigger event that initiates an action at the portable device.

12. A method as recited in claim 11, further comprising communicating a re-register request for the data source before a timeout stops the controllable device from sending the data source to the portable device.

13. A method as recited in claim 11, further comprising:
detecting the trigger event in the data source;
loading media content related to the trigger event; and
executing a browser application to display the media content related to the trigger event.

14. A method as recited in claim 13, further comprising communicating at least a displayable portion of the media content to the controllable device for display, wherein the displayable portion of the media content is HTML data from a Web site that is displayed at the portable device.

15. A method as recited in claim 11, further comprising detecting the trigger event in the data source and displaying an application at the portable device, the application corresponding to media content that is displayed for viewing at the controllable device.

16. A method as recited in claim 11, further comprising receiving a user-generated trigger event that initiates the action at the portable device.

17. A method as recited in claim 11, further comprising:
detecting a television channel, from the data source, that is tuned at the controllable device;
displaying media content that is associated with a television program on the television channel at the portable device;
communicating at least a displayable portion of the media content to the controllable device for approximate synchronous display with the television program that is displayed for viewing at the controllable device.

18. A method implemented by a controllable device, the method comprising:
executing a companion application with a processor of the controllable device, the companion application configured to interface the controllable device with a portable device via a wireless network;
rendering media content for viewing on a display device that corresponds to the controllable device;
communicating a data source to the portable device that monitors the data source for a trigger event, which initiates an action at the portable device;
receiving displayable data from the portable device when the portable device detects the trigger event and displays the data at the portable device;
rendering the displayable data for display along with media content for viewing on the display device that corresponds to the controllable device.

19. A method as recited in claim 18, wherein the data source is at least one of closed-caption data or metadata that is communicated to the portable device.

20. A method as recited in claim 18, wherein:
the media content is a television program that is rendered for viewing on the display device that corresponds to the controllable device;
the displayable data is received from the portable device when the portable device detects, from the data source, a television channel that is tuned at the controllable device; and wherein
the displayable data is rendered for approximate synchronous display along with the television program on the display device that corresponds to the controllable device.
